(19) United States
(12) Patent Application Publication
(10) Pub. No.: US 2012/0023516 A1
(43) Pub. Date: Jan. 26, 2012

(54) SYSTEM AND METHOD FOR VERIFYING HOME TELEVISION AUDIENCE VIEWERSHIP VIA A SET-TOP BOX

(76) Inventors: Robert Wolinsky, Fairfield, CT (US); John Freeman, East Orange, NJ (US)

(21) Appl. No.: 13/188,291

(22) Filed: Jul. 21, 2011

Related U.S. Application Data
(60) Provisional application No. 61/366,459, filed on Jul. 21, 2010.

(51) Int. Cl. H04H 60/33

(52) U.S. Cl. 725/12

(57) ABSTRACT

A system method for determining audience size of home television may include receiving a plurality of viewer confirmation signals, each viewer confirmation signal being responsive to a visual verification signal being displayed and sensed by an optical sensor. Responsive to each viewer confirmation signal that includes an indication of a television channel of multiple television channels being viewed and time at which the visual verification signal was sensed, a data repository may be updated. Viewership of the television channels used during a timeslot may be calculated and reported.

### RELATED APPLICATIONS

This Application claims priority to co-pending U.S. Provisional Patent Application Ser. No. 61/366,459 filed Jul. 21, 2010; the entire contents of which are hereby incorporated by reference in their entirety.

### BACKGROUND

Since the beginning of home television, audience delivery has been the primary measure by which television networks have set advertising rates and by which advertisers have been willing to pay for airtime on television. The business of commercial television is truly a numbers game—the more eyeballs watching, the more advertisers pay.

A problem that has existed in television is audience measurement. Neilsen ratings have been the primary means by which audiences are measured and reported. In making the audience measurement, the measurement is actually a statistical sampling (e.g., measured within 5,000 homes) that is scaled to estimate the audience size for any particular television channel or program. Despite the estimates having inherent inaccuracies, television networks and advertisers have come to accept the Neilsen ratings as the standard by which airtime value is set.

Another problem that exists in estimating audience size is a result of technology used to deliver television to viewers. Set-top boxes, which are used for both cable and satellite television, reside in households of television viewers and allow the viewers to select channels. Over the years, set-top boxes have been modified to allow cable, satellite, television network operators, and measurement entities to collect data from the set-top boxes. Such data includes television channels that are selected and times during which the channels were selected. However, because the set-top boxes are independent devices from the televisions themselves, the viewer may have the television turned off while the set-top box is turned on. As a result, the cable, satellite, television network operators, and measurement entities may receive data indicating that a certain channel is being watched, while in reality, the television is turned off. Still yet, the set-top box may be turned on, but the viewer may be watching a previously recorded show or movie, playing a video game, surfing the Internet via the television, or otherwise. In another scenario, the viewer may use a digital video recorder (DVR) to pause live television for a certain time period, but fast forward through a television program, such as a sporting event. Hence, the cable, satellite, television network operators, and measurement entities may measure that the viewer is watching a particular channel when, in fact, he or she is not or is fast forwarding over programming and/or commercials. As a result of these and other technical issues, audience viewership inaccuracies are increased.

### SUMMARY OF THE INVENTION

Inaccurate audience viewership measurements resulting from conventional audience measurement techniques are reduced using the principles of the present invention. In solving the audience measurement problem, a verification technique using a sensor to determine that a television channel is being displayed on the television may be utilized. In one embodiment, a set-top box may be configured to receive feedback communication signals from the sensor and, in turn, communicate a viewing verification signal to a remote location that is indicative of the television channel being watched. In one embodiment, the sensor may be an optical sensor that is positioned on or in front of a television screen to sense a verification optical signal being displayed along with programming. The visual verification signal may be injected into a broadcast video signal by the cable, satellite, television network operators, and measurement service entities or the set-top box may overlay the visual verification signal over the television video signal. The channel identifier and timestamp may be reported for a viewer to view.

One embodiment of a set-top box for measuring home audience viewership may include a transceiver unit configured to receive and transmit communications signals via a communications network with a head-end system, where the communications signals may include a content signal. A memory may be configured to store television programming information and television channel identifier currently selected. A processing unit may be in communication with the memory and be configured to communicate a video signal of a television channel to a television for display thereon. The video signal may include the content signal and a visual verification signal to be displayed in a region of a television screen. The visual verification signal may be displayed in the region of the television screen by the processing unit. A sensed visual verification signal may be received by the processing unit from an optical sensor positioned to view the visual verification signal. The processing unit may further be configured to determine that the sensed visual verification signal matches the visual verification signal, and associate a timestamp with a channel identifier of each television channel being displayed.

One embodiment of a method of aligning an optical sensor on a television display to sense a visual alignment signal may include generating the visual alignment signal, generating an alignment user feedback signal, causing the alignment user feedback signal to be presented to a user aligning the optical sensor, displaying the visual alignment signal, and in response to sensing a change in the visual alignment signal being displayed while aligning the optical sensor, altering the alignment user feedback signal.

One embodiment of a method for determining audience size of home television may include receiving a plurality of viewer confirmation signals, each viewer confirmation signal being responsive to a visual verification signal being displayed and sensed by an optical sensor. Responsive to, each viewer confirmation signal that includes an indication of a television channel of multiple television channels being viewed and time at which the visual verification signal was sensed, a data repository may be updated. Viewership of the television channels used during a timeslot may be calculated and presented to a user.

One embodiment of a method for measuring home television audience viewership may include optically sensing a visual verification signal associated with a television signal of a selected television channel being displayed on a television screen. A determination that the optically sensed visual verification signal matches the visual verification signal may be made. The selected channel may be reported to a remote location in response to determining that the optically sensed visual verification signal matches the visual verification signal. In one embodiment, a timestamp may be associated with a channel identifier in response to determining that the optically sensed visual verification signal matches the visual verification signal, and the timestamp and channel identifier may be reported. A speed at which the visual verification signal being displayed may be determined and reported. The speed may be determined to be play speed or non-play speed (e.g., fast forward or reverse). In one embodiment, a determination may be made as to whether the visual verification signal is time shifted from an original display.

### BRIEF DESCRIPTION OF THE DRAWINGS

A more complete understanding of the method and apparatus of the principles of the present invention may be obtained by reference to the following Detailed Description when taken in conjunction with the accompanying Drawings wherein:

FIG. 1 is a an illustration of an illustrative home television network environment to which television network service providers provide television communication services and a third-party ratings provider collects and generates television ratings;

FIG. 2 is an illustration of an illustrative home television network environment in which content is delivered to televisions of home viewers and audience viewership is measured using optical sensing at televisions of the home viewers;

FIG. 3A is an illustration of an illustrative set-top box and television configured to measure a visual verification signal displayed on the television for use in measuring home television viewership;

FIG. 3B includes signal diagrams of an illustrative content signal, visual verification signal, and sensed visual verification signal for use in measuring home audience viewership of television channels;

FIG. 4 is a block diagram of illustrative software modules that may be executed on a set-top box for use in measuring home audience viewership of television channels;

FIG. 5A is a flow diagram on an illustrative manual process for aligning an optical sensor in front of a television screen for measuring home audience viewership in accordance with the principles of the present invention;

FIG. 5B is a flow diagram on an illustrative automated process for aligning a visual alignment signal with an optical sensor in front of a television screen for measuring home audience viewership in accordance with the principles of the present invention;

FIG. 6 is a screen shot of an illustrative alignment screen for assisting a user with aligning an optical sensor with a visual verification signal displayed on a television screen;

FIG. 7 is a flow diagram on an illustrative process for generating and displaying a visual verification signal;

FIG. 8 includes signal diagrams of an illustrative visual verification signal and sensed visual verification signal;

FIG. 9 is a flow diagram of an illustrative process for recording channels and timestamps in performing audience measurement;

FIGS. 10A-10D are illustrations of an illustrative television shown to be displaying a visual verification signal;

FIGS. 11A-11D are illustrations of an illustrative television shown to be displaying a visual verification signal;

FIGS. 12A and 12B are illustrations of an illustrative television configuration showing a television, set-top box, and optical sensor;

FIGS. 13A-13C are illustrations of an alternative configuration of an optical sensor mounted to a television; and

FIG. 14 is a flow diagram of an illustrative viewership determination process.

### DETAILED DESCRIPTION OF THE DRAWINGS

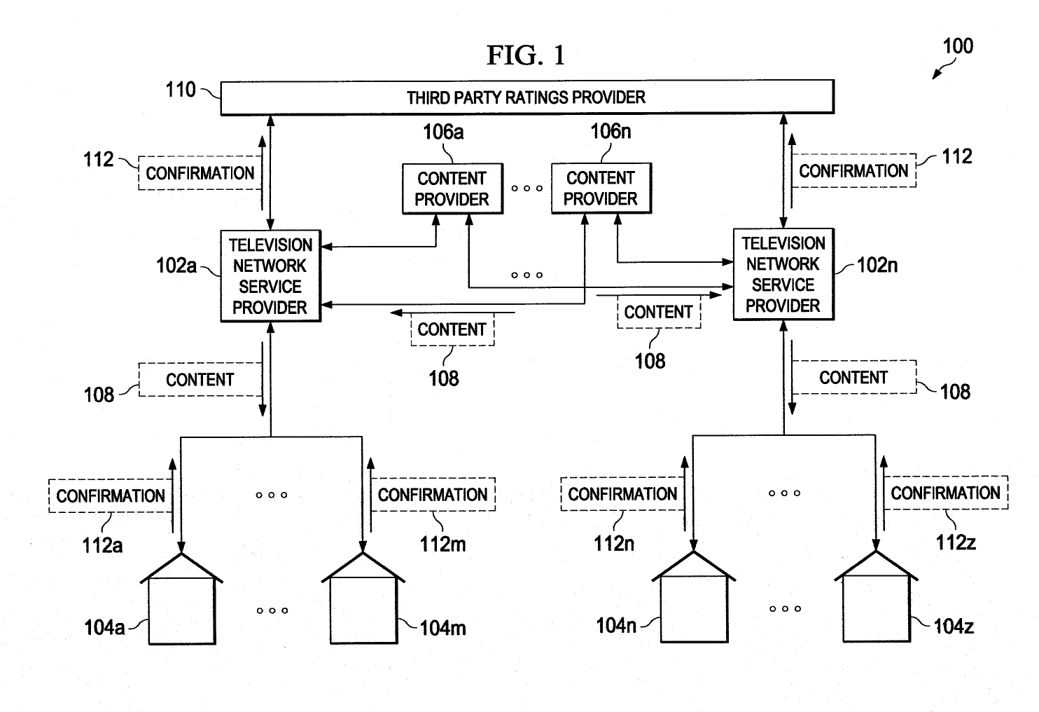

With regard to FIG. 1, an illustrative television network environment network 100 is shown to include television network service providers 102a-102n (collectively 102). The television network service providers may be cable or satellite television network service providers, as understood in the art, and have customers 104a-104m and 104n-104z (collectively 104), respectively. Content providers 106a-106n (collectively 106) may be any television network, such as traditional broadcast networks (e.g., ABC®, NBC®, CBS®, etc.) and cable networks (e.g., HBO®, FOX®, Showtime®, etc.). Each of the content providers 106 provide content 108 to the television network service providers 102 for delivery to their customers or subscribers 104. Content refers to programming, commercials, or other audio visual information displayed on an electronic display (e.g., television).

A third-party ratings provider 110 may be an independent organization that collects data from the television network service providers 102 or directly from the customers 104. As customers or viewers 104 watch television channels, via a set-top box or similar television data television collector device independent of the set-top box, as understood in the art, confirmation signals 112a-112m and 112n-112z (collectively 112) may be communicated back to the television network service providers 102a and 102n respectively, which, in turn, may communicate the confirmation signals 112 to the third-party ratings provider 110. Alternatively, rather than communicating the confirmation signals 112 to the respective television network service providers 102, the confirmation signals 112 may be communicated directly to the third-party ratings provider 110. As described further herein, the confirmation signal 112 may be generated by an optical sensor sensing a visual verification signal from a television screen of a television so that a television channel currently being watched by the customer may be determined and stored for determining television channel viewership during a timeslot.

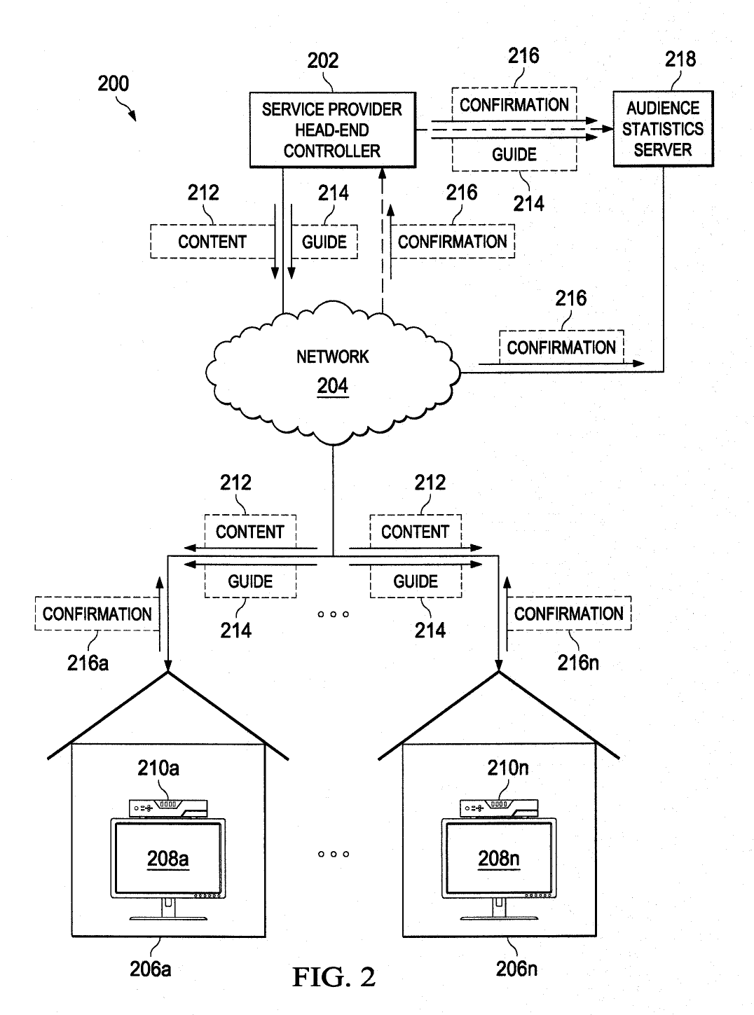

With regard to FIG. 2, an illustrative television network environment in which a service provider head-end controller 202 is in communication with a communications network 204, such as a cable television network or satellite television network, for subscribers 206a-206n to receive television signals from the service provider head-end controller 202 is shown. The customers 206 have television sets 208a-208n (collectively 208) and set-top boxes 210a-210n (collectively 210), respectively, for receiving and displaying television or content signals, as understood in the art.

In operation, the service provider head-end controller 202 may be configured to communicate content 212 and a television guide 214 to each of the set-top boxes 210 for access by viewers to watch the content 212 on the televisions 208. In accordance with the principals of the present invention, the content 212 may have a visual verification signal (not shown) embedded therein or the set-top boxes 210 may generate a visual verification signal and add or overlay the content 212 with the visual verification signal (not shown) for display on the televisions 208. Optical sensors (not shown) may sense the visual verification signals and, in response to the set-top boxes 210 receiving sensed visual verification signals from the optical sensors, generate and communicate confirmation signals 216a-216n (collectively 216) to an audience statistics server 218. In one embodiment, the audience statistics server 218 may be located at a television network service provider or third-party ratings provider, as provided in FIG. 1. Alternatively, rather than communicating the confirmation signals 216 to the audience statistics server 218, the confirmation signals 216 may be communicated to the service provider head-end controller 202, which, in turn, may communicate the confirmation signals 216 to the audience statistics server 218. In addition, the guide 214 may be communicated to the audience statistics server 218 to enable the audience statistics server 218 to correlate information in the confirmation signals 216 with channels and/or content being watched.

The visual verification signal may be generated in a couple of different ways. In one embodiment, if the content 212 is to have embedded therein a visual verification signal, the visual verification signal may be embedded within the content 212 in a position of the content data such that the visual verification signal is displayed in a predetermined location of a television screen, such as lower tight-hand corner. The embedding of the visual verification signal may be performed by a service provider distributing the content, agency for an advertiser, advertiser, or any other party prior to delivery of the content from the head-end controller 202. Although not shown, the visual verification signal may be separately communicated to the set-top boxes 210 for display with the content as managed and performed by the set-top boxes 210.

In addition, the visual verification signal may be established to have a size of a certain number of pixels or dimensions, such as a 5 by 5 pixel array or 10 millimeters by 10 millimeters, for example. A larger number of pixels may be utilized as well. In embedding the visual verification signal into the content signal 212, an editing system or automated visual verification signal overlay or mixing system may be used to integrate the visual verification signal into the content signal 212. Alternatively, rather than the visual being embedded into the content signal 212, the set-top boxes 210 may be configured to generate the visual verification signal and overlay the visual verification signal onto the content signal 208. Still yet, the set-top boxes 210 may communicate the visual verification signal to the television separately from the content signal and the television may overlay the visual verification signal over the content signal when displayed. The set-top boxes may be configured to generate the visual verification signals to have certain numbers of pixels or dimensions. In addition, the visual verifications signals may have certain colors or frequencies, such as (i) black and white or (ii) red, green, and blue (simultaneously or sequentially), to enable optical sensing to more easily identify the visual verification signals being displayed on the televisions 208. In one embodiment, a colored visual verification signal may provide the viewer and/or advertiser with color calibration data if the optical sensor is configured to measure color in addition to intensity.

The visual verification signals may be generated by using data representative of a television channel, content name, timeslot, or any other information that may be used to allow the audience statistics server 218, for example, to determine that a television channel and/or content (e.g., programming, commercials, etc.) is being watched at a particular time or over a time duration. The visual verification signals may include identifiers that identify programming content, commercial (e.g., advertiser name, product identifier), or otherwise so that specific watching actions (e.g., fast forward, channel change during commercials etc.) can be tracked. In one embodiment, the visual verification signals may be generated by the set-top boxes 210 looking up data stored in their memories (not shown), including television channel currently selected, content being displayed on the currently selected television channel, network name associated with the currently selected television channel, and so forth, which may be available from the guide information 214 that is stored on the set-top boxes 210. If, alternatively, the content 212 is embedded with the visual verification signals by a content provider or television network service provider, then the same or different data may be used in generating the visual verification signals. Additionally or alternatively, the visual verification signal may be formed from a signal pattern that is independent of a television channel, content information, or any other information associated with the content, content provider, television channel, television network, etc.

In response to an optical sensor sensing the visual verification signal, the set-top box 210 may generate a confirmation signal 216 that includes a television channel identifier and timestamp, for example, that may be stored by the audience statistics server 218 for use in generating audience size of each television channel. Alternatively, if “raw” data (i.e., measured visual verification signal data without being processed to determine content) is communicated to the audience statistics server 218 or other remote computing system from the set-top boxes 210, then the audience statistics server 218 or other remote system may generate a verification signal that includes the channel and timestamp. In one embodiment, the set-top boxes 210 may generate and collect audience statistics over a given time period, such as a day, week, or month, and report the audience statistics in the confirmation signal 216 to the audience statistics server 218, thereby alleviating the amount of processing that the audience statistics 218 has to perform as compared to if a confirmation signal 216 were communicated to the audience statistics server 218 each time a visual verification signal were sensed at each of the televisions 208.

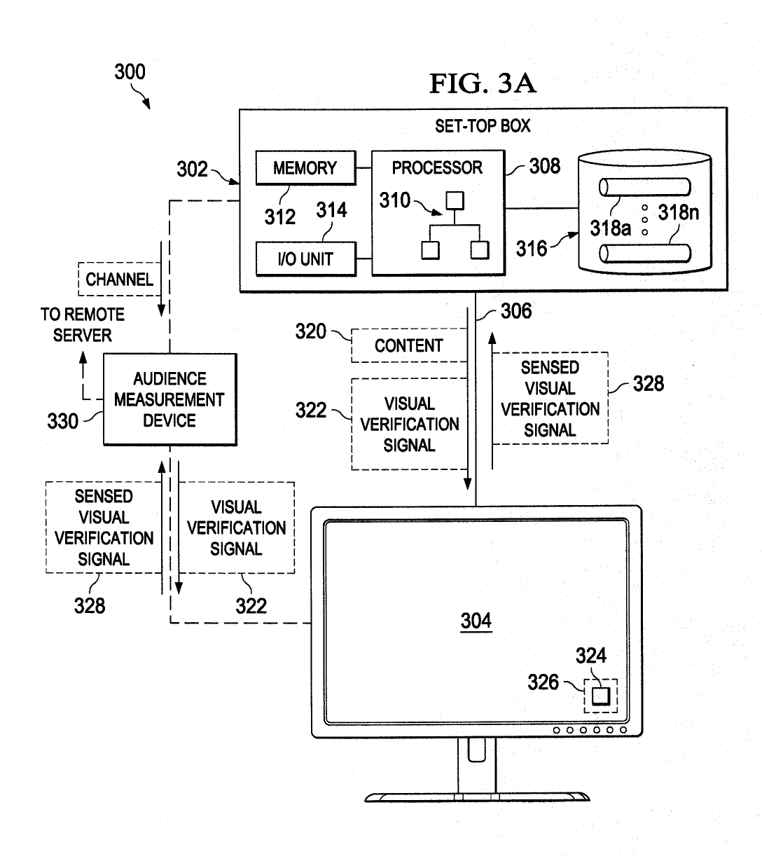

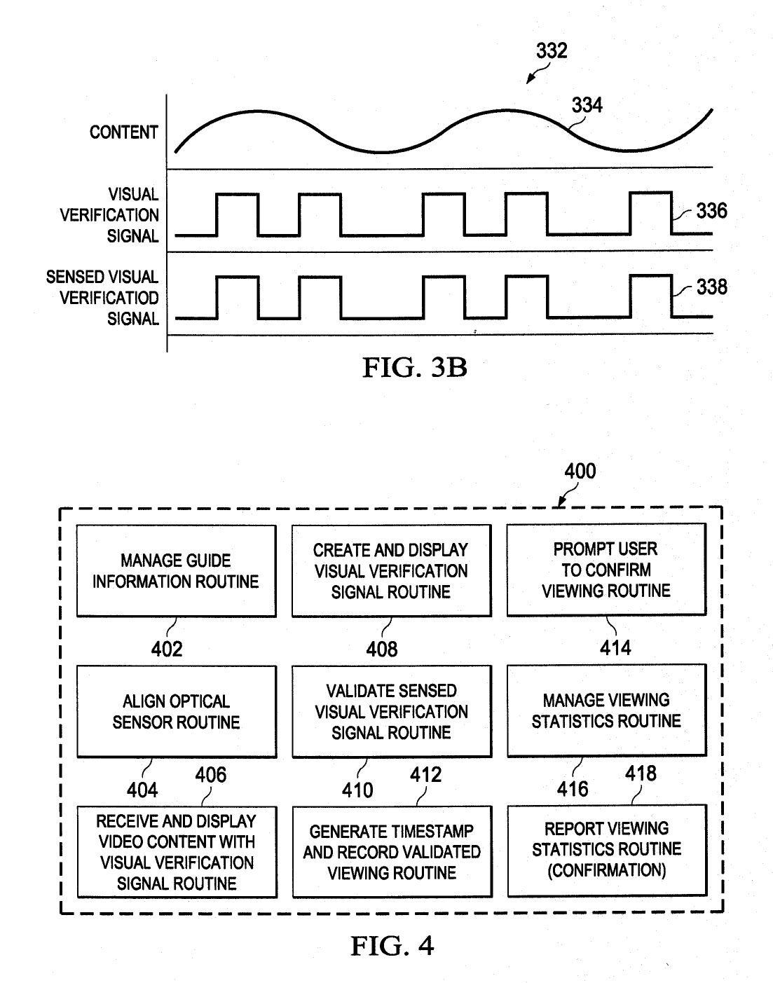

With regard to FIG. 3A, an illustrative configuration of a television unit 300 is shown to include a set-top box 302 in communication with a television 304 via a communications path 306. The communications path 306 may be a wired and/or wireless communications path. The set-top box 302 may include a processing unit 308 and includes one or more processors that execute software 310. The software 310 may be configured to perform traditional set-top box processing to receive, decode, and communicate content signals to the television 304 along with performing visual verification signal processing in accordance with the principles of the present invention. The processing unit 308 may further be in communication with a memory 312, input/output unit 314, and storage unit 316. The storage unit 316 may store one or more data repositories 318a-318n (collectively 318) that are capable of storing content and visual verification signal data representative of viewership of members of a residence in which the television 304 resides.

In operation, the set-top box 302 may communicate content signals 320 and visual verification signals 322 to the television 304 for display thereon. The visual verification signals 322 may be embedded in the content signals 320 and is provided by a content provider or television network service provider, as described with regard to FIG. 2. Alternatively, the visual verification signals 322 may be superimposed onto the content signals 320 by the processing unit 308 or other hardware of the set-top box 302. As previously described, the visual verification signals 322 may be displayed in a particular region of the television screen of the television 304, such as location 324 in the lower right-hand corner of the television screen. The number of pixels in which the visual verification signal 322 are displayed may be set by the processing unit 308 or by the content provider or television network service provider. In one embodiment, the number of pixels in which the visual verification signal 322 are displayed is based on resolution or pixel size of the television 304. If the television 304 is an analog television, then the size and position of the visual verification signal displayed on the television may be set by the number of horizontal and vertical lines in which the visual verification signal is displayed.

An optical sensor 326 may include one or more sensor elements and may be disposed in front of the location 324 in which the visual verification signal 322 is displayed. In one embodiment, the optical sensor 326 may be a CCD optical sensor or image sensor. The optical sensor 326 may be in communication with the set-top box 302 via the wired or wireless communications path 306 to provide measurements made by the optical sensor 326. As shown, the optical sensor 326 is shown to be slightly larger than the location 324 that is being used to display the visual verification signal. By having the optical sensor slightly larger than the location 324 of displaying the visual verification signal 322, or at least include a cover for an optical sensor element(s), ambient and external light from the television 304 may be reduced, thereby providing the optical sensor 326 with the ability to measure the visual verification signal 322 with fewer errors. The size of the optical sensor 326 and optical sensor element(s) may be determined by pixel size of the television, resolution of the television, and so on. In response to the optical sensor 326 sensing the visual verification signal 322 being displayed in the location 324, the optical sensor 326 may communicate a sensed visual verification signal 328 to the set-top box 302 for processing thereon. Alternatively, the optical sensor 326 may be configured to communicate the sensed visual verification signal 328 to a remote device other than the set-top box 302 via a different communications path, such as via a wireless router located in the residence in which the television 304 is located. The software 310 may be configured to process the sensed visual verification signal 328, as further described herein in FIG. 4 and other figures.

As an alternative embodiment, an audience measurement device 330 that may be in communication with the television 304 and set-top box 302 may be configured to perform the same, similar, or portions of the functionality for generating and sensing the visual verification signal 322 and sensed visual verification signal 330, respectively, and for processing and reporting viewership information, as described above and with regard to FIG. 4. Data from the set-top box, such as current channel selected, guide data, or other program data, may be communicated from the set-top box 302 to the audience measurement device 330. The audience measurement device 330 may be in communication with a network, such as the Internet, cable network, and/or satellite network to communicate a confirmation signal that may include viewership information (e.g., channels viewed, associated timestamp, viewer or equipment identifier) from sensing the visual verification signal displayed by the television 304.

With regard to FIG. 3B, signal diagrams 332 include a content signal 334, a visual verification signal 336, and sensed visual verification signal 338. The content signal 334 may be an analog or digital signal that is communicated from the set-top box 302 to the television 304, as understood in the art. The visual verification signal 336 may also be analog or digital depending upon how the set-top box 302 delivers the content signal 334 to the television 304 for display thereon. However, as shown, the visual verification signal 336 is shown to be a digital signal. The sensed visual verification signal 338 is a signal that is generated by the optical sensor 326 based on measurements of the visual verification signal 336. The sensed visual verification signal 338 is shown to be digital in nature, but the sensed visual verification signal 338 may alternatively be analog. Depending upon whether the various signals 334, 336, and 338 are analog or digital determines where analog-to-digital and digital-to-analog converter devices are to be electrically located in the set-top box 302 and/or television 304, as understood in the art. In the event that the visual verification signal is a two-dimensional indicia (e.g., QR code), then the sensed visual verification code is digital and representative of the two-dimensional visual verification signal having multiple data fields.

With regard to FIG. 4, a block diagram of illustrative software modules 400 that may be executed by the processing unit 308 (FIG. 3A) are shown. The software modules 400 may include a managed guide information routine 402 that is configured to manage a guide of television programming that is downloaded to the set-top box 302, as understood in the art. The guide being managed may include channel number, program name, channel network name (e.g., NBC®), time segment of the television program, information about the television program, and so on.

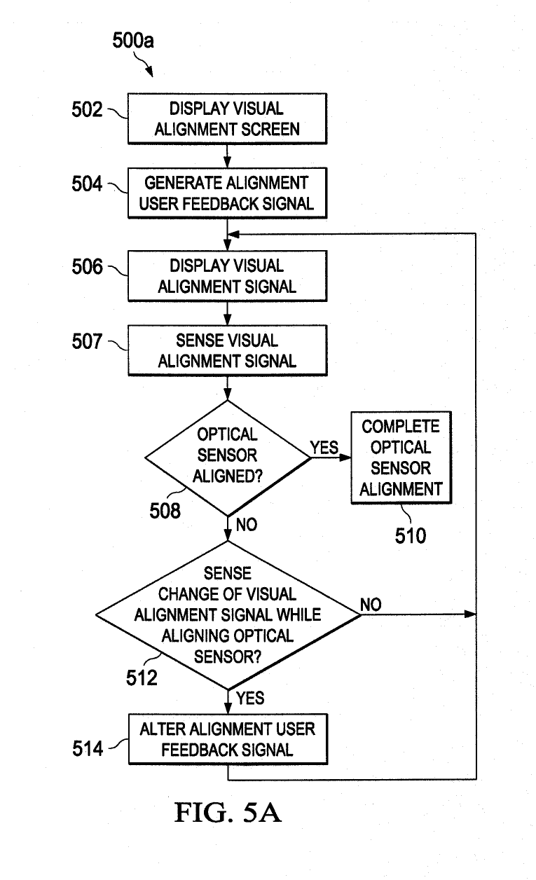

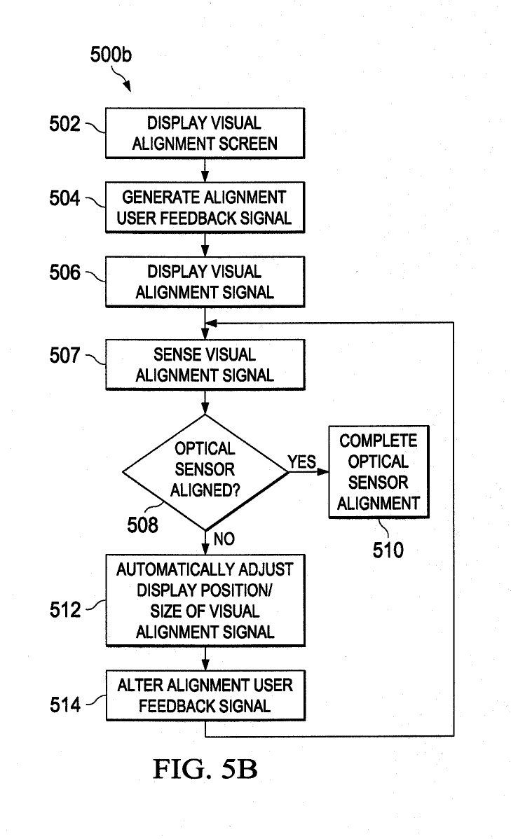

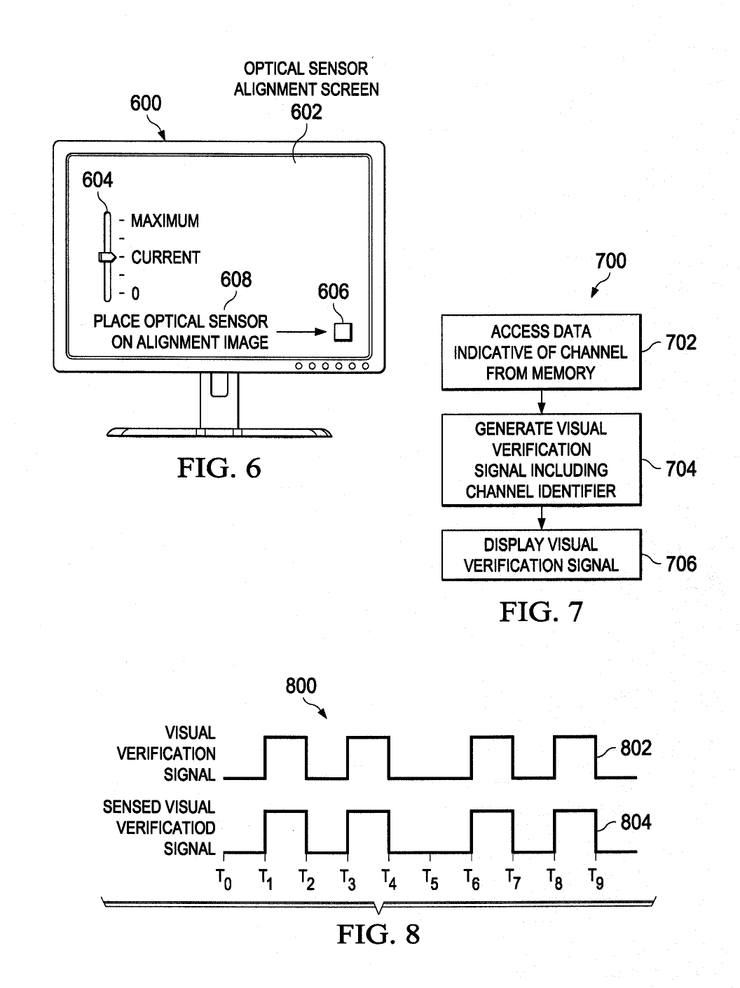

An align optical sensor routine 404 may be configured to assist a user with aligning an optical sensor on to the television to be positioned in front of a location in which a visual verification signal is to be displayed. The align optical sensor routine 404 may be configured to display instructions on a television screen of the television, such as presented in FIG. 6. In addition, the align optical sensor routine 404 may be configured to blank or turn the television screen a certain color and display a visual alignment signal on the screen for the user to align the optical sensor in front of the alignment signal. A manual process as described in FIG. 5A may be performed to properly align the optical sensor with the visual alignment signal being displayed. Alternatively, an automated alignment process as described in FIG. 5B may be performed to properly align the visual alignment signal with the optical sensor positioned in front of the television screen.

A receive and display video content with visual verification signal routine 406 may be configured to receive a content signal (i) with a visual verification signal or (ii) without a visual verification signal. If the content signal is received without a visual verification signal, then the routine 406 may obtain a visual verification signal from another software routine, such as a create and display visual verification signal routine 408.

The create and display visual verification signal routine 408 may be configured to generate a visual verification signal by generating a standard visual verification signal that is displayed with all content no matter which channel is being displayed and, optionally, be channel or content independent. Alternatively, the routine 408 may access guide information based on a current channel that is selected and use information associated with the channel, program, or any other content that may be used to indicate what channel or content is being viewed. It should be understood that there may be a variety of different ways for generating a visual verification signal that may be used by an audience auditor or ratings provider to determine the size of the audience. Because the processing unit 308 of the set-top box 302 has the ability to determine a channel that is currently selected, the visual verification signal does not have to be complex or indicative of a channel or content being viewed (i.e., be channel and content independent), as the processing unit 308 or other remote system can determine that information (i.e., channel and content) in response to the visual verification signal being sensed by an optical sensor.

The visual verification signal may be formed of a code that is binary, hexadecimal, decimal, alphanumeric, or any other code that may be used in verifying that a channel is being displayed. For example, the code may include a hexadecimal character or string value, such as 9A2B_{H} or 10110010₂, for example. Alternatively, the code may be indicative of a channel that is currently being watched, such as 004₁₀. Still yet, the code may be an ASCII code representative of a name of a television program that is currently being watched, such as “Jeopardy.” Still yet, the code may be a combination of television channel program name, predetermined code, or any other indicia that may be helpful in identifying a channel and/or program that is currently being viewed. The code may be a multi-field code that includes different information in the different fields, where the fields are designated by delimiters. In yet another embodiment, a timestamp of a time that the visual verification signal is displayed may be included with the code that is used to form the visual verification signal. Including a timestamp in the visual verification signal may be utilized in measuring time-shifted content (i.e., content and commercials that are recorded on a DVR of the set-top box and replayed). Alternatively, rather than including a timestamp in the visual verification signal, a timestamp may be generated in response to the visual verification signal being sensed. In one embodiment, the visual verification signal may have a preamble and/or postamble so that the start and/or end of the visual verification signal may be identified. The visual verification signal may be looped and be continuously or non-continuously displayed during the display of content (e.g., programming and advertising).

A validate sensed visual verification signal routine 410 may be configured to validate that a visual verification signal is the same as the visual verification signal that was communicated to the television for display thereon. As shown in FIG. 3B, the validation may occur by matching the visual verification signal 332 with the sensed visual verification signal 334. If validated, the routine 410 may generate a Boolean value that is indicative of the visual verification signal being sensed or not being sensed. In one embodiment, the validate sensed visual verification signal routine 410 may be configured to determine speed of content being viewed (e.g., commercials being fast forwarded) so that advertisers can be provided information that the advertiser's advertisement was displayed, but at a fast forwarded speed. Alternatively, rather than determining actual speed of display of content, the validate sensed visual verification signal routine 410 may collect viewership information that identifies timestamps during which content is displayed at play speed and non-play speed (e.g., fast forward or reverse) so that reports may be generated for advertisers to determine play speed viewership of advertisements, for example.

A generate timestamp and record validated viewing routine 412 may be configured to be responsive to the validate sensed visual verification signal routine 410 by generating a timestamp in response to the routine 410 confirming or validating that a visual verification signal is sensed. In addition to generating a timestamp in response to the visual verification signal being sensed, other information, such as channel currently being viewed, program name, or any other information may be recorded at the set-top box 302 (FIG. 3A). It should be understood that rather than recording the timestamp and other information on the set-top box 302, that the recording of the validation may be performed by communicating a confirmation signal 216 (FIG. 2) to a remote location. The confirmation signal may include a timestamp, address associated with the user, or any other information that may enable the remote location to determine when the verification occurred, where the verification occurred, etc.

TABLE I is an illustrative table showing viewership information that includes viewer ID, channel, timestamps, and content identifier. It should be understood that additional and/or different information indicative of viewership information may be stored. In addition to keeping a specific list of each channel and timestamps, an aggregated list of the information may be stored. The viewership information is shown for a single viewer. However, viewership information may be centrally collected from each viewer and combined in a single or multiple data repositories so that overall viewership information may be calculated, thereby showing total audience size, commercial viewings during a timeslot, time shifted viewing of content, or any other viewership metric that may be of interest to a broadcaster, advertiser, or agency.

TABLE I
Viewership Information

| Viewer ID | Channel | Timestamps | Content |
|---|---|---|---|
| A384721 | 4 | 7/7/11 8:00 pm: 8:42 pm | 4718T4 |
| A384721 | 7 | 7/7/11 8:42 pm: 9:06 pm | 9723C8 |
| A384721 | 342 | 7/7/11 9:06 pm: 10:30 pm | 9741P1 |
| . . . | . . . | . . . | . . . |

A prompt user to confirm viewing routine 414 may optionally be used to monitor how long a particular channel has been viewed and, if the channel has been viewed for longer than a predetermined time without any activity (e.g., channel changing, set-top box being turned off, etc.), then the routine 414 may cause the processing unit 308 to generate a prompt to the user to respond in a given time period (e.g., 5 minutes). If the user does not respond within a given time period by using a remote control to indicate that he or she is actively viewing the channel selected, then the routine 414 may notify another routine, such as a managed viewing statistics routine 416, to stop recording that the user is still part of the audience. In one embodiment, the predetermined time period or duration that the user may have to respond to the prompt may be long enough that a viewer who has gone to the kitchen to prepare a sandwich or retrieve a drink, gone to the bathroom, placed a telephone call, or other activity that would still qualify the user as being an active viewer may be utilized. In one embodiment, the predetermined time duration may be five minutes. The prompt may have a countdown timer displayed next to the prompt so that the user recognizes that a predetermined time period has been set. If a user does not respond within the predetermined time period, then that same prompt may be maintained on the screen of the television so that, in the event that the user returns to the television, the user may respond, thereby causing the routine 414 to notify another routine that the user is again an active viewer and is to be added to the audience. Alternatively, rather than maintaining the previous prompt, another prompt, such as “press any key to indicate that you are actively viewing the television again.” It should be understood that if the user does not respond to a prompt produced by the routine 414, that the process of sensing a visual verification signal and validating that the visual verification signal has been displayed may be suspended until the user or viewer actively notifies the routine 414 that he or she is again watching the television.

A managed viewing statistics routine 416 may be configured to generate, collect, and/or store viewing statistics in response to the visual verification signal being verified. The managed viewing statistics routine 416 may be capable of aggregating viewer statistics during timeslots (e.g., half-hour timeslots) to provide a summary of the viewing statistics, which may thereafter be communicated from the set-top box 302 to a remote server for further aggregation with other subscribers using set-top boxes. The managed viewing statistics routine 416 may be configured to store timestamp, channel, television program, or any other information that may be desired by an advertiser, advertising agency, or any other organization that may have a desire in tracking viewership for advertising or other purposes. For example, the managed viewing statistics routine 416 may collect statistics of speed that commercials are viewed as determined by the validate sensed visual verification signal routine 410 or through the set-top box tracking time(s) within a timeframe that the set-top box is playing real-time (e.g., not fast forwarded, reverse, or pause). In addition, the managed viewing statistics routine 416 may tabulate time delay offsets by comparing date/time of content (e.g., programming and/or commercials) of first run and date/time of content when actually displayed (and redisplayed) and store data representative of time offset content, as advertisers and broadcasters may desire to know what content is time shifted and how many times, for example. In one embodiment, the managed viewing statistics routine 416 may be integrated with DVR functionality (e.g., fast forward, record, rewind, pause) in collecting and generating statistics of channel and, optionally, commercial viewing.

A report viewing statistics routine 418 may be configured to generate and/or communicate viewing statistics that are being managed by the managed viewing statistics routine 416 to a remote location. The report viewing statistics routine 418 may be configured to send a confirmation signal, such as that described in FIG. 2, to a remote server, such as the audience statistics server 218. The routine 418 may be configured to send one or more data parameters that may be utilized by the remote location to track viewership of television channels. For example, the data parameters may include channel and timestamp. Alternatively, the data parameter may include an indication that a certain channel was watched for a certain period of time during a certain time segment (e.g., channel 4; 12.2 minutes between 3:30 and 4:00 pm; content time shifted; commercial 86271 watched real time). It should be understood that a variety of different data parameters may be utilized in accordance with the principles of the present invention to report viewing statistics. Still yet, the report viewing statistics routine 418 may report on content that is time shifted, as collected by the managed viewing statistics routine 416.

With regard to FIG. 5A, a flow diagram of an illustrative process 500 for manually aligning an optical sensor on a television screen of a television is shown. The process 500 start at step 502, where a visual alignment screen may be displayed on the television screen. The visual alignment screen may be one that notifies a viewer that he or she is to place an optical sensor at a certain location on the television screen (see, FIG. 6). The visual alignment screen may be a blank screen or have a certain color so as to distinguish a visual verification signal displayed in a distinct location on the television screen. For example, the color of the visual alignment screen may be black and the color of the visual verification signal may be white.

At step 504, an alignment user feedback signal may be generated. The alignment user feedback signal may be a visual aid that is displayed on the visual alignment screen and/or an audible signal that is presented to the user via speakers of the television. The alignment user feedback signal initially may be set to a low or no value, such that a user can tell that visual verification signal is not being sent. In one embodiment, the alignment user feedback signal may be a graph or other visible aid that allows a user to know that he or she has a certain accuracy in aligning the optical sensor with the visual verification signal. It should be understood that any indicia may be utilized, such as a series of bars that increase in height incrementally, such as those used on mobile telephones. If the alignment user feedback signal is audible, then a continuous tone may be generated and frequency may be increased as the alignment improves. Alternatively, a geiger counter sound may be generated and as the user aligns the optical sensor with the visual verification signal being displayed the geiger counter sound speeds up its ticks. Still yet, a voice, either recorded or synthesized, may say “cold,” “warmer,” and “hot,” as the user is aligning the optical sensor in front of the visual verification signal.

A display visual alignment signal 506 may be configured to display a visual alignment signal, which may be the same or similar to that as a visual verification signal with the exception that the visual alignment signal may be used for alignment purposes. In one embodiment, the visual alignment signal may be a solid color. Alternatively, the visual alignment signal may be a test pattern that causes the visual verification signal to blink so that the optical sensor may be tested as it is being aligned. Still yet, the visual alignment signal may be a solid until the user completes the alignment process and then a test visual verification signal may be performed to verify that the optical sensor and set-top box perform correctly. At step 507, the visual alignment signal may be sensed by the optical sensor.

At step 508, a determination may be made that the optical sensor is aligned. In one embodiment, the determination may be made by a user that is aligning the optical sensor with respect to the visual alignment signal. The determination may be made by a visual inspection, by listening to an audio tone, by an algorithm determining that an optical power level being sensed by optical sensor is above a threshold value. If the optical sensor is determined to be aligned, then the process continues at step 510, where the optical sensor alignment process is complete. Alternatively, if it is not determined that the optical sensor is aligned at step 508, then the process may continue at step 512. It should be understood that the determination that the optical sensor is aligned may be performed automatically by displaying a notice on the television screen that the optical alignment process is complete and to affix or otherwise maintain position of the optical sensor at its current location. If an audible alignment user feedback signal is used, then a notification to the user that the optical sensor is aligned may be audibly presented to the user. The use of an audible alignment user feedback signal allows the user to be able to concentrate on the alignment process without having to divert his or her visual attention to the television. However, either or both of the alignment user feedback signals may be utilised in accordance with the principles of the present invention.

At step 512, a determination may be made as to whether a change of visual alignment signal while aligning the optical sensor has been sensed. A change in the visual alignment signal may be sensed as the user changes position of the optical sensor over the visual alignment signal being displayed on the television screen. In other words, as the user moves the optical sensor over the visual alignment signal, more or less of the visual alignment signal may be sensed by the optical sensor. If no change in the visual alignment signal is sensed, then the process returns to step 506 or, alternatively, step 508. If, however, a change of the visual alignment signal is sensed at step 512, then the process continues at step 514 where the alignment user feedback signal is altered (e.g., increase or decrease frequency of an audible tone), as described with regard to step 504. The alignment process 500 continues until the user has properly aligned the optical sensor. Alternatively, if the user does not complete the alignment process, the alignment process 500 may be terminated. In completing the optical sensor alignment process at step 510, a timestamp as to when the optical alignment process 500 was completed may be stored for later access or reporting to a remote location so that any third party ratings provider or other party may be notified that the user is now part of a tracking audience.

With regard to FIG. 5B, a flow diagram of an illustrative process 500b for automatically aligning a visual alignment signal with an optical sensor. In this automated alignment process 500b, rather than the user moving the position of the optical sensor, software is used to automatically reposition and/or resize the visual alignment signal with the optical sensor that is already positioned with respect to the television screen. The process 500b operates in a similar manner as the process 500a as shown in FIG. 5A, with the exception that in response to determining that the optical sensor is not aligned at step 508, the process continues to step 512, where the display of the position and/or size of the visual alignment signal is automatically adjusted. In automatically adjusting the position and/or size of the visual alignment signal may utilize a procedure that moves the position of the visual alignment signal in a predetermined pattern to find the edges of the optical sensor by measuring power levels being sensed (e.g., move from left to right and top to bottom to sense when power increases and decreases). In an alternative embodiment, the visual alignment signal may start large and change the dimensions (e.g., lower top edge until power drops, then raise bottom edge until power drops, move right edge left until power drops, move left edge right until power drops). As the power drops, the position on the screen of each of the edges of the visual alignment signal may be recorded so that the visual verification signal may be sized according to the dimensions automatically determined to by the automatic alignment process. At step 514, the alignment user feedback signal may be altered so that the user knows that the automated process is happening.

With regard to FIG. 6, a television 600 showing a screen shot of an illustrative optical sensor alignment screen 600 is shown. The optical sensor alignment screen 600 may include an alignment user feedback signal 604 that allows the user to see how well the optical sensor is aligned with the visual alignment signal 606. In addition, directions, such as “place optical sensor on alignment image” may be presented to the user to assist the user in understanding what he or she is to do for aligning the optical sensor with the visual alignment signal 606 being displayed on the optical sensor alignment screen. It should be understood that alternative display information may be utilized in accordance with the principles of the present invention to assist the user in aligning an optical sensor with a visual alignment signal 606.

With regard to FIG. 7, a flow diagram of an illustrative process 700 for generating and displaying a visual verification signal is shown. The process 700 starts at step 702, where data indicative of a channel currently selected for viewing may be accessed from memory. The data may be in the form of a channel number, station identifier, program name, or any other information that may assist in identifying what channel is currently being displayed. At step 704, a visual verification signal including the channel identifier may be generated. The visual verification signal may be in a digital or analog form and may include the channel identifier, such as channel number, represented in a digital or analog form. If in the digital form, the channel identifier may be represented in a digital format, such as 0100₂ representing channel 4. When the channel identifier is displayed as a visual verification signal on the television screen, an OFF, ON, OFF, OFF representation is displayed as a series of outputs that are sensed or not sensed, if ON or OFF, respectively, by the optical sensor. At step 706, the visual verification signal is displayed, as previously described. It should be understood that alternative formats, such as QR codes or display of actual characters (e.g., “4”) may be displayed and read by a two-dimensional image sensor.

To assist a user with the alignment process of the optical sensor, a template (not shown), which may be formed of clear plastic or other material, may be provided to a user. The template may be sized to allow the user to more easily locate the visual verification signal displayed on the television screen. For example, the template may be aligned to a lower right corner of a television and have an opening 2-inches diagonally from the lower right corner.

With regard to FIG. 8, signal diagrams 800 including a visual verification signal 802 and sensed visual verification signal 804 are shown. Each of the verification signals 802 and 804 are shown to be digital in form and substantially identical to one another, at least with respect to time periods during which each of the signals 802 and 804 are HIGH and LOW. If such matching patterns exist, it may be determined that the visual verification signal has been sensed and that the viewer is actively watching the content being displayed at that time. If QR codes, barcodes, characters, or other two-dimensional indicia are displayed, comparison of the displayed characters or codes may be made. In the event of using two-dimensional indicia, the indicia may be static (i.e., a fixed indicia throughout a time duration) or dynamic (i.e., indicia that changes on a periodic basis, such as every video frame, every second, every content change, etc.), so that time shifting of content can be more easily identified.

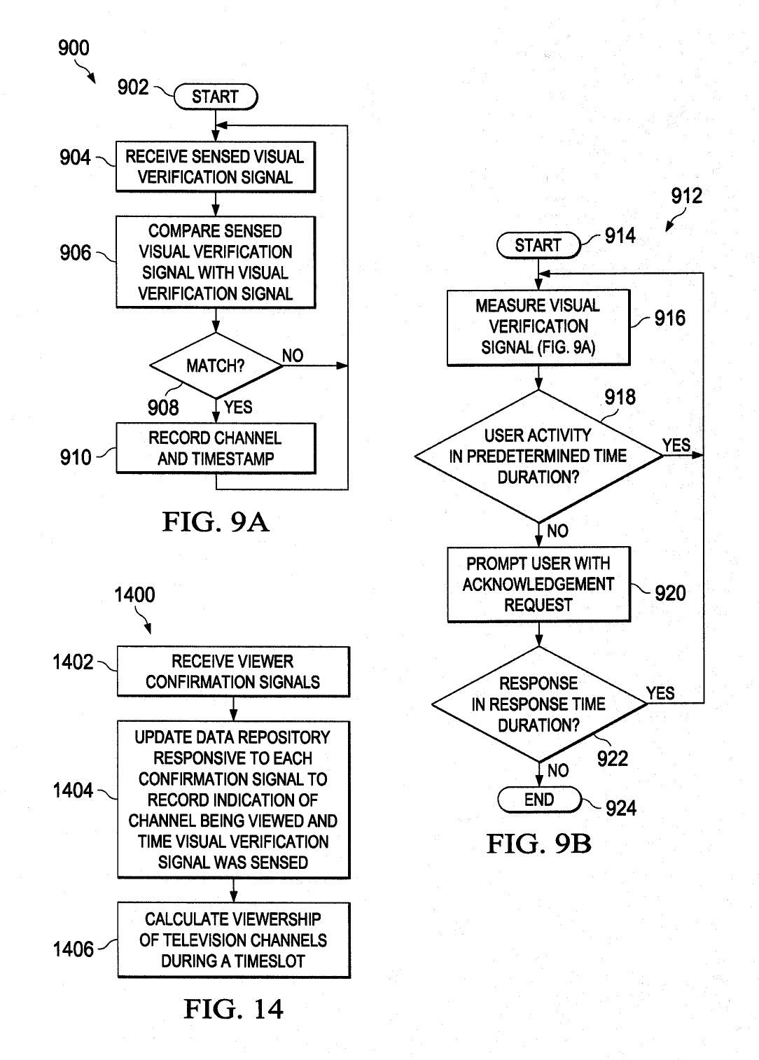

With regard to FIG. 9A, a flow chart of an illustrative process 900 for determining whether a viewer is watching a particular channel is presented. The process 900 starts at step 902. At step 904, a sensed visual verification signal may be received. A sensed visual verification signal may be received via a wire or wirelessly from an optical sensor. At step 906, the sensed visual verification signal may be compared with the visual verification signal that was displayed. At step 908, a determination may be made as to whether the sensed visual verification signal matched the visual verification signal. If a match is determined, then at step 910, a channel and timestamp may be recorded. The process may return to step 904 thereafter. If a match is determined not to have been made, the process may return to step 904. It should also be understood that if a match is not made that a notice may be presented to a user by the television or optical sensor turning on or flashing an LED or beeping to indicate that the optical sensor may not be properly aligned with the visual verification signal. An indication may be made to perform the alignment process of FIG. 5 again or the alignment process may be automatically activated. Other options may be performed if a match is determined not to have been made, as well.

With regard to FIG. 9B, a flow diagram of an illustrative process for monitoring active viewing of a television is provided. The process 912 starts at step 914. At step 916, a visual verification signal may be measured (see FIG. 9A). At step 918, a determination may be made as to whether user activity has been detected within a predetermined time duration, such as one-hour. If a user activity, such as changing a channel, increasing or decreasing volume, muting the television, or performing any other activity of which the set-top box is involved, then a determination is made that user activity has been performed and the process 912 returns to step 916. Alternatively, if no user activity has occurred within the predetermined time duration at step 918, and then the process continues to step 920, where the user is prompted with an acknowledgement request. The acknowledgement request may request that the user press a certain key or any key on a remote control to acknowledge that he or she is actively watching the current channel. Because the user knows that he or she is being monitored for ratings purposes, such a prompt is unlikely to be a distraction to the user. If, at step 922, the user responds within the time duration, then the prompt may be removed from the television screen and the process return to step 916. Alternatively, if the user does not respond within the time duration, then the process may continue at step 924 to end the process 912. Alternatively, a different prompt may be displayed on the television that requests that the user actively acknowledge that he or she is now watching the television so that the set-top box may resume tracking or acknowledging that a user is actively watching the television. During a time period that the user does not acknowledge the acknowledgement request prompt and acknowledges a prompt for resuming watching the television, the process of monitoring or verifying the visual verification code may be suspended, such that the user is no longer considered part of the viewing audience. It should be understood that the prompt at step 920 may be displayed for a certain time period, such as five minutes, during which the user is to acknowledge that he or she is watching the television before the prompt is withdrawn and the process 912 determines that the user is no longer actively watching the television.

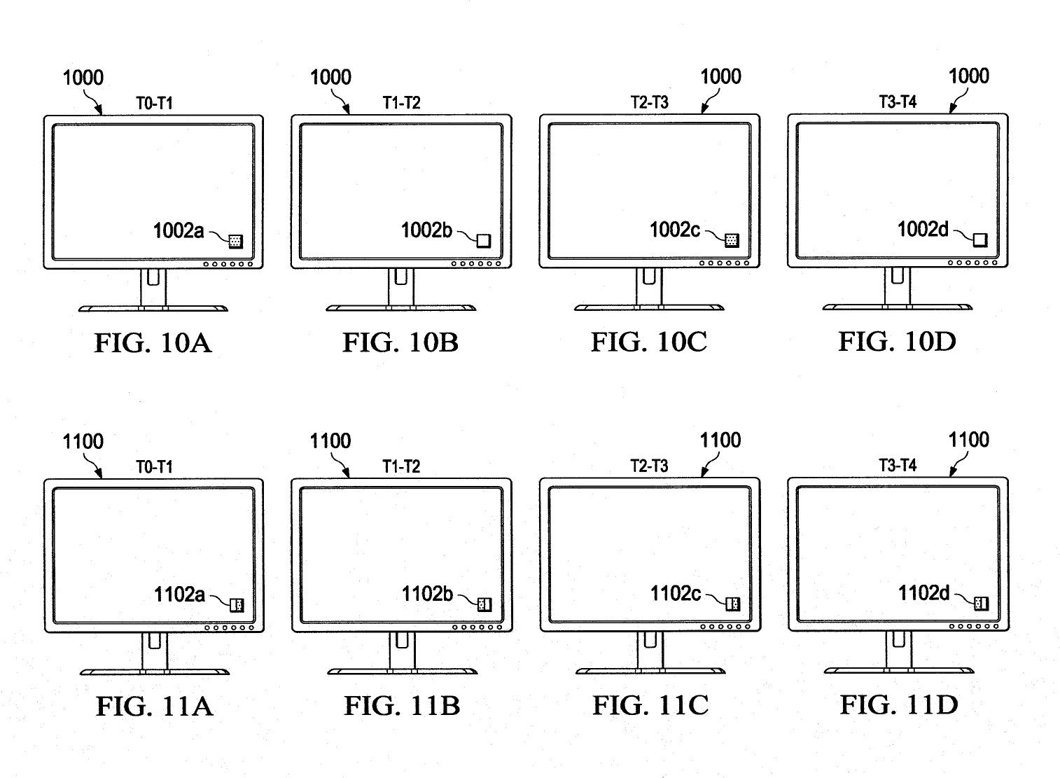

With regard to FIGS. 10A-10D, illustrations of an illustrative television 1000 is shown to be displaying a visual verification signal 1002a-1002n (collectively 1002) over different time periods. The different time periods extend between T0-T1, T1-T2, T2-T3, and T3-T4. During each of these time periods, the visual verification signal 1002 is shown to be in a different state (i.e., OFF (black), ON (white), OFF (black), ON (white)), which is representative of a 5₁₀ (0101₂). The time periods may be regular time intervals. Alternatively, the time periods may be aperiodic. As previously described, if the television is a digital television that uses pixel elements (e.g., LCD, OLED, etc.), multiple pixels elements (e.g., 5×5 pixel array, 100×100 pixel array) may be utilized for displaying the visual verification signal.

With regard to FIGS. 11A-11D, illustrations of an illustrative television 1100 is shown to be displaying a visual verification signal 1102a-1102n (collectively 1102) over different time periods. By contrast to the visual verification signals 1002 of FIGS. 10A-10D, the visual verification signals 1102 are displayed using multiple regions, in this case black and white on different sides of the pixel array. Although shown as being two different colors on different horizontal sides of the pixel array, it should be understood that the different colors could be separated on top and bottom, inside and outside concentric boxes or circles, or any other pattern. It should further be understood that colors other than black and white could be utilized, such as red and blue. By using multiple colors, an optical sensor having two or more optical elements may be utilized and a differential measurement may be performed to determine whether the visual verification signal over a given time period is ON or OFF (i.e., ‘1’ or ‘0’). By using differential sensing, ambient and external lighting conditions may have reduced affect on the ability to sense the visual verification signal. Alternative visual verification signal generation and measurement techniques may be utilized, such as those presented in U.S. Pat. No. 7,614,065, which is incorporated herein by reference in its entirety. In one embodiment, as opposed to being different numerical codes, the visual verification signal may include different shapes for different meanings, such as play and different levels of fast forward (e.g., square, circle, “X,” “O,” triangle, etc). Still yet, two-dimensional indicia may be displayed and sensed, as described herein.

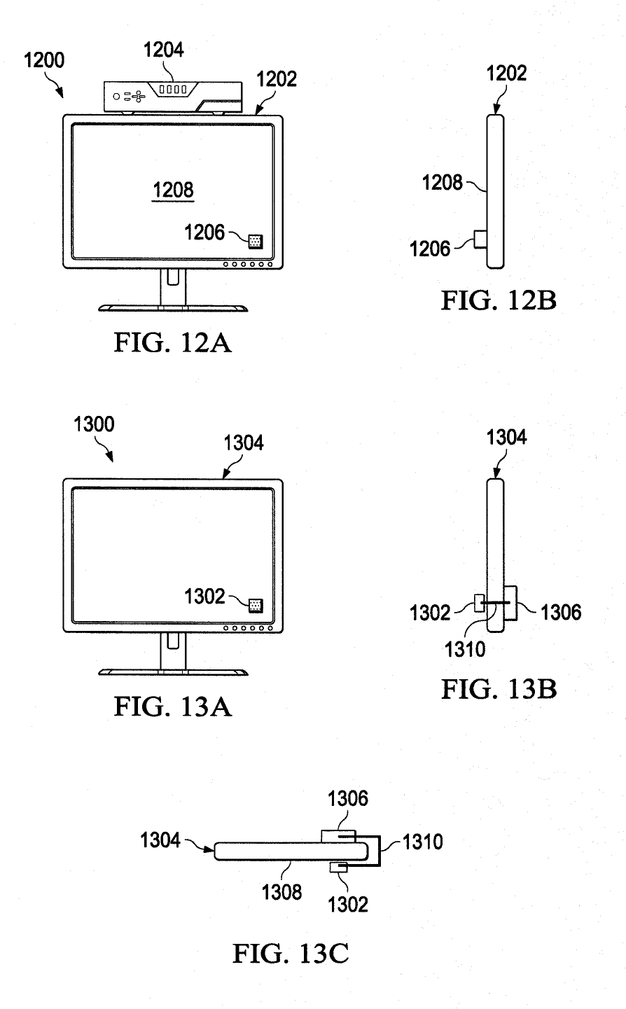

With regard to FIGS. 12A and 12B, illustrations of an illustrative television configuration 1200 showing a television 1202, set-top box 1204, and optical sensor 1206 are shown. Attached to the television is the illustrative optical sensor 1206 for sensing visual verification signals in accordance with the principles of the present invention. The optical sensor 1206 is shown as a black square. However, as the size of the optical sensor element (not shown) of the optical sensor 1206, which may include the optical sensor element, housing, and other electronics, may be very small, the optical sensor 1206 may be translucent or semi-translucent to reduce distracting a view that is watching the television. The optical sensor 1206 may be attached to a glass screen 1208 (See, FIG. 12B) of the television 1202 using an adhesive. Other methods of attaching the optical sensor 1206 in a non-permanent or permanent manner may be utilized in accordance with the principles of the present invention.

With regard to FIGS. 13A-13C, illustrations of an alternative configuration of an optical sensor 1302 mounted to a television 1304 are shown. The optical sensor 1302 in this case is not connected to a glass screen 1306 of the television 1304, but rather held in place by a bracket 1306 that secures to a housing 1308 of the television 1304. The bracket 1306 may be secured to the rear, side, front, or top of the housing an adhesive or one or more fastening members (e.g., screws). A positioning member 1310 that may be formed of wire or other stiff structural material (e.g., plastic) may be used to secure the optical sensor 1302 to the bracket 1306. In one embodiment, an electrical conductor may be utilized to conduct sensed visual verification signals from the optical sensor 1302 to electronics (not shown) mounted within the bracket 1306. To provide for alignment capabilities, the positioning member 1310 or other coupling member (not shown) at the bracket 1306 or optical sensor 1302 end of the positioning member 1310 may enable a user to adjust position and orientation of the optical sensor 1302.

With regard to FIG. 14, a flow diagram of an illustrative viewership determination process 1400 is shown. The process 1400 starts at step 1402, where viewer confirmation signals are received. The viewer confirmation signals may be notifications that a visual verification signal was verified, which would allow for a remote system to timestamp the confirmation signals. Alternatively, the viewer confirmation signals may include other information, such as viewer ID (e.g., set-top box MAC address, IP address, serial no., subscriber ID, etc.), selected television channel, and/or any other information that may be useful in determining viewership during a given timeslot.

At step 1404, a data repository responsive to each confirmation signal may be updated to record an indication of a channel being viewed and time the visual verification signal was sensed. The time may include timestamps. Alternatively, rather than collecting timestamps, a time segment during which the television channel was selected may be stored in a data repository (e.g., database). At step 1406, viewership of television channels during a timeslot may be calculated or otherwise tabulated. The calculation may be performed in the update step 1404 may increment a total viewership value. In another embodiment, rather than just indicating that a television channel was watched during a time segment, specific times during the time segment may be identified so that advertisers and agencies may determine whether or not commercials are being watched or whether the viewer becomes a channel “surfer” during commercials. As with current viewership ratings calculations, extrapolation or scaling formulas may be utilized to compute a total estimated viewership. Using the principles of the present invention, however, total viewership is likely to be more accurate as sensing verification signals being displayed provides knowledge that is currently unavailable by simply determining channel of the set-top box. It should be further understood that the principles of the present invention may be applied to electronic display devices other than traditional televisions, including computers, mobile devices with electronic displays, display monitors, and so forth.

The previous description is of a preferred embodiment for implementing the invention, and the scope of the invention should not necessarily be limited by this description. The scope of the present invention is instead defined by the following claims.

What is claimed is:

1. A set-top box for measuring home television audience viewership, said set-top box comprising:
a transceiver unit configured to receive and transmit communications signals via a communications network with a head-end system, the communications signals including a content signal;
a memory configured to store television programming information and television channel identifier of a television channel currently selected; and
a processing unit in communication with said memory and transceiver unit, and configured to:
communicate a video signal of the television channel to a television for display thereon, the video signal including the content signal and a visual verification signal to be displayed in a region of a television screen;
display the visual verification signal in the region of the television screen;
receive a sensed visual verification signal from an optical sensor positioned to view the visual verification signal being displayed;
determine that the sensed visual verification signal matches the visual verification signal;
associate a timestamp with the channel identifier of the television channel being displayed in response to determining that the sensed visual verification signal matches the visual verification signal; and
reporting the channel identifier and timestamp for a user to view.

2. The set-top box according to claim 1, wherein said processing unit is further configured to communicate a viewer confirmation signal to a remote location to indicate that a viewer is displaying a particular channel on the television.

3. The set-top box according to claim 2, wherein the confirmation signal includes the timestamp and channel identifier.

4. The set-top box according to claim 1, wherein said processing unit is further configured to:
generate a set of data records that include timestamps and channel identifiers over a time period;
store the set of data records; and
communicate, via said transceiver unit, the set of data records to a remote location.

5. The set-top box according to claim 1, wherein said processing unit, in determining that the sensed visual verification signal matches the visual verification signal, is further configured to determine that the sensed visual verification signal matches the visual verification signal continuously over a given time period.

6. The set-top box according to claim 1, wherein said processing unit is further configured to generate the visual verification signal.

7. The set-top box according to claim 6, wherein said processing unit generates the visual verification signal by accessing a portion of the memory storing the television channel identifier currently being watched and including the television channel identifier in the visual verification signal.

8. The set-top box according to claim 1, wherein said processing unit is further configured to overlay the visual verification signal over the content signal.

9. The set-top box according to claim wherein the content signal includes the visual verification signal embedded therein.

10. A method of aligning an optical sensor on a television display to sense a visual alignment signal, said method comprising:
generating the visual alignment signal;
generating an alignment user feedback signal;
causing the alignment user feedback signal to be presented to a user aligning the optical sensor;
displaying the visual alignment signal; and
in response to sensing a change in the visual alignment signal being displayed while aligning the optical sensor, altering the alignment user feedback signal.

11. The method according to claim 10, wherein generating the alignment user feedback signal includes generating an audible signal, and wherein altering the alignment user feedback signal includes changing frequency of the audible signal in response to the optical sensor sensing higher and lower signal strength of the visual alignment signal.

12. The method according to claim 10, wherein generating the alignment user feedback signal includes generating a visual display signal, and wherein altering the alignment user feedback signal includes changing the visual display signal in response to the optical sensor sensing higher and lower signal strength of the visual alignment signal.

13. A method for determining audience size of home television, said method comprising:
receiving a plurality of viewer confirmation signals, each viewer confirmation signal being responsive to a visual verification signal being displayed and sensed by an optical sensor;
updating a data repository responsive to each viewer confirmation signal that includes an indication of a television channel of a plurality of television channels being viewed and time at which the visual verification signal was sensed; and
calculating viewership of the television channels during a timeslot.

14. The method according to claim 13, wherein updating the data repository includes incrementing viewership of the television channels during a timeslot in response to an indication that a television channel is being watched.

15. The method according to claim 13, wherein receiving the viewer verification signals includes receiving a summary of television channels watched during one or more timeslots.

16. The method according to claim 13, further comprising:
in response to receiving each viewer confirmation signal, determining which television channel is being watched by an associated viewer.

17. A method for measuring home television audience viewership, said method comprising:
optically sensing a visual verification signal associated with a television signal of a selected television channel being displayed on a television screen;
determining that the optically sensed visual verification signal matches the visual verification signal; and
reporting the selected channel to a remote location in response to determining that the optically sensed visual verification signal matches the visual verification signal.

18. The method according to claim 17, further comprising:
associating a timestamp to a channel identifier in response to determining that the optically sensed visual verification signal matches the visual verification signal; and
wherein reporting includes reporting the timestamp and channel identifier.

19. The method according to claim 17, wherein determining includes determining a speed at which the visual verification signal is being displayed.

20. The method according to claim 17, wherein determining includes determining whether the visual verification signal is time shifted from an original display; and
wherein reporting includes reporting that the visual verification signal was sensed at a different time than the original display time.
